(19) United States
(12) Patent Application Publication
(10) Pub. No.: US 2008/0090046 A1
(43) Pub. Date: Apr. 17, 2008

(54) PLASTIC MATERIAL

(75) Inventors: Wilfried Ensinger, Nufringen (DE); Lawrence G. Resavage, Bethel Park, PA (US)

Correspondence Address: LEYDIG VOIT & MAYER, LTD, 700 THIRTEENTH ST. NW, SUITE 300, WASHINGTON, DC, 20005-3960, US

(73) Assignee: ENSINGER KUNSTSTOFFTECHNOLOGIE GBR, Nufringen (DE)

(21) Appl. No.: 11/762,434

(22) Filed: Jun. 13, 2007

Related U.S. Application Data
(63) Continuation-in-part of application No. PCT/EP05/13620, filed on Dec. 17, 2005.

(30) Foreign Application Priority Data
Dec. 20, 2004 (DE) 10 2004 062 799.1

(51) Int. Cl. B32B 3/02; B29C 47/00; B32B 33/00; B32B 7/12; C08K 3/14

(52) U.S. Cl. 428/66.4; 264/625; 428/339; 428/343; 524/413

(57) ABSTRACT

In order to make a plastic material available for the production of tribologically stressed components, in particular, retaining rings for holding semiconductor wafers in chemical mechanical polishing devices, retaining rings produced therefrom, with which noticeably longer service lives of the retaining rings can be obtained, as well as a process for their production, it is disclosed that the plastic material comprises a plastic matrix and particulate TiC embedded therein.

This application is a continuation-in-part of International application No. PCT/EP2005/013620 filed on Dec. 17, 2005.

The present disclosure relates to the subject matter disclosed in International application No. PCT/EP2005/013620 of Dec. 17, 2005 and German application No. 10 2004 062 799.1 of Dec. 20, 2004, which are incorporated herein by reference in their entirety and for all purposes.

### BACKGROUND OF THE INVENTION

The invention relates to a plastic material which is suitable in general for the production of tribologically stressed components, in particular, retaining rings for holding semiconductor wafers in chemical mechanical polishing devices, as well, components produced therefrom as well as a process for their production.

The tribologically stressed components, for the production of which the plastic material according to the invention is suitable, are manifold. These include amongst many others, for example, deflection rollers, guiding elements and other components stressed by sliding friction which are used during the production of wires and the coating of wires. Furthermore, vanes and guiding blades of turbines and generators, rotor parts for compressors and vacuum pumps should be mentioned.

Furthermore, guide bushings, areal bearings and the like are typical fields of use for the plastic material according to the invention.

Piston seals and guide parts for ballistic bodies are also components, for the production of which the plastic material according to the invention is very well suited.

Retaining rings of the type described at the outset are described, for example, in U.S. Pat. No. 6,251,215 and are likewise components, for which the plastic material according to the invention can be used with considerable advantages. Retaining rings are an extreme example for components which are highly stressed tribologically, for which reason the description of the present invention is based to a great extent on the problems occurring with the retaining rings.

Today, integrated circuits are typically produced on semiconductor substrates, in particular, silicon wafers, wherein conductive, semiconductive and insulating layers are deposited one after the other on the wafer. Once each layer has been deposited, etching is carried out in order to realize the circuit functions. Once a row of layers has been sequentially mounted and etched, the uppermost surface of the semiconductor substrate, i.e., the outermost surface of the substrate becomes more and more uneven. This uneven surface causes problems in photolithographic steps during the production process for the integrated circuits. For this reason, it is necessary time and again to make the surface of the semiconductor substrate flat or rather to level it.

For this purpose, the so-called chemical mechanical polishing (CMP) represents one of the recognized methods. This process for achieving the flatness typically requires the substrate, i.e., the semiconductor wafer to be mounted on a support or also polishing head. The accessible surface of the substrate is then pressed against a rotating polishing disk. A regulated force is exerted on the substrate via the supporting head in order to press this against the polishing disk. A polishing medium which contains at least one chemically reactive agent and abrasive particles is placed on the surface of the polishing disk.

One of the most important cost factors with respect to the CMP is the interchange of worn retaining rings since this leads to considerable stop periods for the machines.

In contrast to U.S. Pat. No. 6,251,215, considerably improved retaining rings which are, in particular, also easier and quicker to interchange are suggested in US patent applications US 2004-0065412 A and US 2004-0067723 A, to which reference is made in full.

A reduction in the abrasion of the retaining rings during the CMP still has considerable significance for the economic efficiency of the wafer production despite the improvements which have been achieved.

The object of the present invention is to propose a plastic material for the production of tribologically stressed components, in particular, retaining rings, with which noticeably longer service lives can be obtained for the components.

### SUMMARY OF THE INVENTION

This object is accomplished by the plastic material defined in claim 1.

In an embodiment, the invention provides a plastic material for the production of tribologically stressed components, wherein the plastic material comprises a plastic matrix and particulate TiC embedded therein.

### BRIEF DESCRIPTION OF THE SEVERAL VIEWS OF THE DRAWING(S)

FIG. 1 shows the abrasion characteristics of plastic rings consisting of standard PPS and plastic rings produced in accordance with an embodiment of the invention from PPS filled with TiC particles.

FIG. 2 shows the abrasion characteristics of plastic rings consisting of standard PEEK and plastic rings produced in accordance with an embodiment of the invention from PEEK filled with TiC particles.

FIG. 3 shows a summary of the abrasion values of different high performance plastic materials contrasted with one another.

FIGS. 4 and 5 show, schematically, retaining rings according to embodiments of the invention, which have wear and tear layers, with a plastic matrix into which TiC particles are integrated.

The retaining ring shown in FIG. 4 (with an enlarged sectional illustration in FIG. 4a) has in the wear and tear layer an amount of TiC particles which is greater adjacent to the abrasively stressed surface than in areas which are not subject to any abrasion.

FIG. 5 (with an enlarged sectional illustration in FIG. 5a) shows a retaining ring with a TiC particle distribution which is further modified.

### DETAILED DESCRIPTION OF THE INVENTION

TiC is a very hard material (Vickers hardness 3400) and so with its use as an additional substance added to the plastic materials which are fed to a sliding friction application, as is the case for CMP, problems are more likely to occur on account of increasing abrasion than the solution to the problem of the service lives of the plastic material being too short. Surprisingly, TiC may be integrated into a plastic matrix such that components with considerably improved sliding friction properties and service lives are obtained.

In this respect, the linear thermal coefficient of expansion of TiC, which is at 0.02% at 315°, is also advantageous and so the plastic matrix can be selected with respect to the requirements resulting from the respective application and, where applicable, modified further without consideration needing to be given to the TiC particles. In the same way, their low thermal conductivity of approximately 0.041 cal/sec cm ° C. has a favorable effect on the plastic materials according to the invention which contain TiC. As a result, the heat occurring during sliding friction applications is prevented from being transferred quickly to the surrounding plastic matrix.

Surprisingly, a noticeable reduction in the wear and tear on the components produced from the plastic material is found in the case where the TiC particles are embedded in a plastic matrix in accordance with the invention.

In the case of the retaining rings, grooves worked into their surface, which are open towards the polishing surface of the CMP apparatus and extend from the interior of the ring as far as its outer circumference, see to it that resulting abrasion of the retaining ring is thrown off outwards together with polishing agent and the wafer is thus protected from any contact with the abrasion containing TiC.

The plastic material used according to the invention for the plastic matrix is preferably selected from polyether ether ketone, polyphenylene sulfide, polyparaphenylene, PTFE-modified polyether ether ketone, PFA-modified PTFE, polyether ketone ketone, polyalkylene terephthalate, polyimide, polyamide imide and polysulfone, in particular, polyphenylene sulfone and polyether sulfone.

These materials are particularly suitable for the embedding of the TiC particles and display inherently favorable properties as plastic material for the tribologically stressed components and, in particular, the CMP application. Furthermore, these materials are easy to process.

The amount of TiC particles in the plastic matrix may vary within broad limits. Satisfactory effects in the case of self-reinforcing plastics, such as polyparaphenylene, are already displayed with an amount of 3% by weight. In the case of plastics without self-reinforcing effects, amounts of 10% by weight or more are, however, recommendable for optimum wear resistance.

As a rule, the amount of TiC particles will be limited to at the most 30% by weight on account of the costs of the TiC particles, on the one hand, and tribological aspects, on the other hand. High amounts may be recommendable, in particular, when the costs of the plastic material for the matrix are higher than the costs for the TiC particles which then also have the effect, apart from the reduction in wear and tear, of making the plastic material cheaper. For many applications, a good spectrum of characteristics may be achieved in the components produced with an amount of 20% by weight or less.

In the case of applications, with which high temperatures result, very good results are achieved with amounts of 15 to 25% by weight, the range of 20 to 25% by weight is even more preferred.

The TiC material is preferably used in a fine-particle form, i.e., with particle sizes of smaller than 10 μm. Particularly preferred are TiC particles with average particle sizes of 1 to 2 μm, even more preferred 1.2 to 1.4 μm.

These particle sizes are, on the one hand, small enough not to cause any malfunctions and, on the other hand, are sufficiently large to considerably improve the abrasion resistance.

The preferred particle form of the TiC particles is granular, in particular, spherical.

For many applications, TiC particles with a smooth, i.e., non-fissured surface are advantageous.

In order to ensure that the TiC particles are well embedded in the plastic matrix, these are preferably treated with an adhesion agent before they are worked into the plastic material. The particles are preferably provided with a layer of adhesion agent.

Alternatively or in addition, it may be provided for the TiC particles to be partially fluorinated. As a result of this, as well, the binding to a plastic matrix may be improved.

Polymer materials, which are compatible, on the one hand, with the TiC and, on the other hand, with the selected plastic material of the matrix, are particularly suitable as adhesion agents. Preferred layers of adhesion agent contain a fluorinated polymer. In addition or alternatively, the adhesion agent can contain groups which may be caused to react with the plastic material of the matrix so that a covalent binding between the adhesion agent and the matrix plastic material may be provided.

The invention relates, in addition, to components, in particular, retaining rings for semiconductor wafers in chemical mechanical polishing (CMP) equipment and retaining rings for hard disc lapping equipment which are produced with the use of the plastic material described above. In these applications the superior abrasion resistance and dimensional resistance of the inventive plastic material is of specific importance.

Other suitable components produced with the use of the described plastic material include, for example:

Material handling/conveyor components such as rollers, pins, and bumpers. In these components several of the advantageous properties of the inventive plastic material are of high importance, namely the improved wear resistance, the low coefficient of friction, chemical resistance, hardness and dimensional stability. Pulleys and sheaves made of the inventive plastic material benefit especially from the hardness and wear resistance of the inventive plastic materials. Other more specific examples include deflection rollers, guiding elements and other components stressed by sliding friction which are used during the production of wires and the coating of wires.

Thermoforming and cupping equipment components, especially pistons and molds. In these applications the wear resistance and dimensional stability of the inventive plastic material is of importance.

Static and dynamic seals, particularly in the form of seal rings, especially take advantage of the high abrasion resistance and dimensional stability of the inventive plastic material. Piston ring seals are more specific examples which, in addition, take advantage of the improved hardness of the inventive plastic material.

Armor components for automobiles and air craft benefit from the hardness and the specific high speed mechanical properties of the inventive plastic material.

Pump components, especially gyrators, seals, fittings (e.g., inlet and outlet fittings) and vanes, are advantageously manufactured using the inventive plastic material. The hardness, wear resistance and dimensional stability are of importance here. Similar aspects exist for guiding blades of turbines and generators, as well as rotor parts for compressors and vacuum pumps.

The inventive plastic material may especially used in the manufacture of splines and gears which benefit from the hardness and wear resistance.

Additional applications for components produced with the use of the plastic material include, for example, guide bushings, areal bearings and the like; as well as piston seals and guide parts for ballistic bodies.

Components according to embodiments of the invention can include a wear and tear layer, as described below.

The components according to the invention do not necessarily require a homogeneous distribution of the TiC particles in the plastic matrix although this often represents the simpler embodiment with respect to production techniques.

The TiC particles in the plastic matrix adjacent to abrasively stressed surface areas of the components will preferably be present in a greater amount than in areas which are not subject to any abrasive stressing.

In addition or alternatively, areas of the components located radially inwards can have a lower amount (in a stepped or continuously decreasing manner) of TiC particles or, even more preferred, be essentially free from TiC particles. This has the additional advantage that the use of TiC particles is limited to the areas of the component which are subject to abrasive stressing and that any undesired contact with TiC particles can practically be ruled out, for example, in the case of retaining rings with the semiconductor wafer.

Components, in particular, retaining rings which are covered by the latter embodiment can be provided, for example, with a wear and tear layer which is derived from a tubular semi-finished product which is produced by way of co-extrusion of an inner wall free from TiC and a concentric outer wall containing TiC.

The different amounts of TiC particles in the wear and tear layer of the components may also be realized, of course, with other production processes, such as, e.g., a sintering process.

The invention relates, in addition, to a process for the production of components, as defined in claims 17 and 18.

It is of significance for the production processes that the plastic materials filled with TiC are subjected to a specific temperature control after their forming in order to achieve a predetermined degree of crystallization of the matrix plastic material, on the one hand, and to minimize tensions in the component, on the other hand.

These and other advantages of the invention will be explained in greater detail in the following in conjunction with the examples and the drawings.

### EXAMPLES

### Abrasion and Wear Test

The abrasion and wear values were determined for the plastic materials described in the following examples with a so-called Buehler machine (Buehler Phoenix 4000 type 49-4101-260 of Buehler Ltd., Lake Bluff, Ill., USA) under the following conditions:

Polishing Medium (Slurry):

Semisperse SS-12 oxide slurry of the Cabot Microelectronics, Research and Technology Center, Aurora, Ill., USA.

A urethane sliding plate of the type Rodel CR1C1400-A-3 of Rohm & Haas CMP Development Center, Newark, Del., USA was used as polishing disk.

The Buehler machine was driven at 150 rpm in counter rotation, the contact pressure of the retaining ring in relation to the sliding plate was 3.8 psi at a rotational speed of 196.25 ft/min.

Test Specimens

For test purposes, a plastic ring was produced from an extruded hollow bar consisting of the respective plastic materials with an external diameter of 320 mm and an internal diameter of 290 mm and a height of 12 mm, wherein a homogeneous distribution of the TiC particles in the plastic matrix is provided with use of the respective plastic materials according to the invention.

TiC particles coated with fluorocarbon polymer were used as TiC particles which are sold by Pacific Particulate Materials Ltd. (Port Coquitlam, B.C., Canada) under the name TiC-2201. These TiC particles have a very narrow particle size distribution of 1.2 to 1.4 μm.

The TiC particles were, first of all, compounded with the plastic material for the matrix of the rings and, subsequently, the compound was processed by way of extrusion to form hollow bars, from which the rings were then separated. The hollow bars were subjected to tempering in order to influence the crystallinity and in order to reduce tensions present in the material.

The tempering conditions for materials based on PEEK and PPS were the following:

Heating up: 3 h at 120° C. oven temperature

4 h at 220° C. oven temperature
   Holding time at 220° C.: 1½ h per cm wall thickness
   Cooling rate: 20° C./h until a temperature of 40° C. is reached

### Example 1

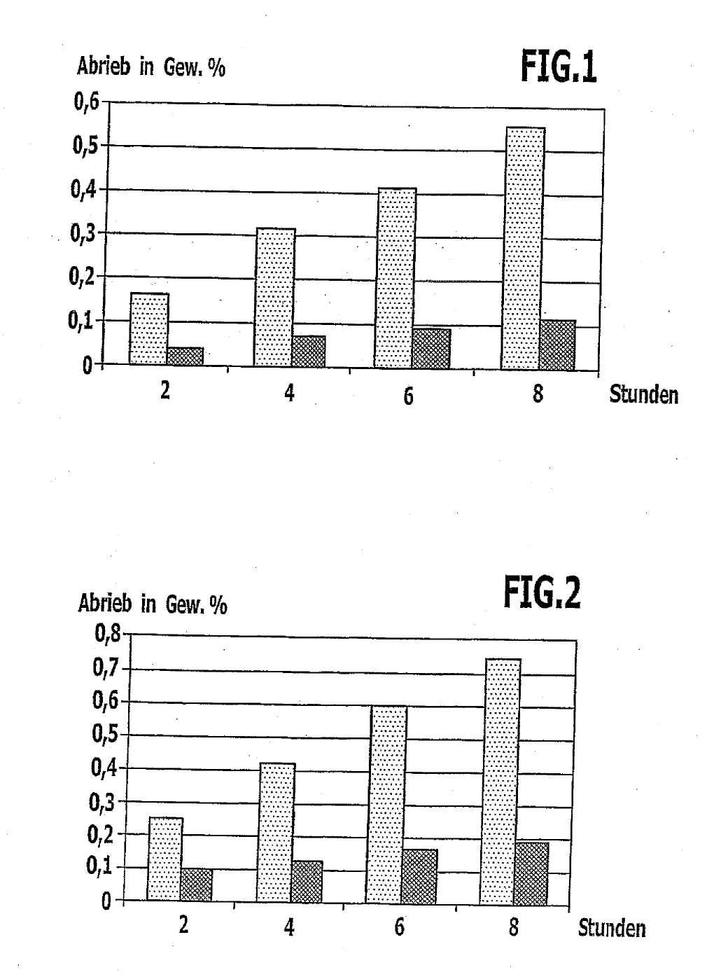

In this example, the abrasion characteristics of plastic rings consisting of standard PPS and PPS with a proportion of 22% by weight of TiC particles were examined. The data from the tests are illustrated in FIG. 1, wherein the respective left-hand column in the diagram represents the result of the ring produced from standard PPS and the respective right-hand column the rings produced in accordance with the invention from PPS filled with TiC particles.

As a result, it may be ascertained that the abrasion in the case of the rings according to the invention is still considerably less, even after eight hours of testing, than in the case of the values observed for standard PPS after one hour of testing.

### Example 2

In this example, the abrasion characteristics of plastic rings consisting of standard PEEK and PEEK with a proportion of 22% by weight of TiC particles were examined. The data from the tests are illustrated in FIG. 2, wherein the respective left-hand column in the diagram represents the result of the ring produced from standard PEEK and the respective right-hand column the result of the ring produced in accordance with the invention from PEEK filled with TiC particles.

As a result, it may be ascertained that the abrasion in the case of the rings according to the invention is still considerably less, even after eight hours of testing, than in the case of the values observed for standard PEEK after one hour of testing.

The abrasion values were somewhat higher than the values observed for the PPS materials but still many times below the abrasion values which were obtained for the ring produced from unfilled standard PPS material.

### Example 3

In this case, a so-called self-reinforcing polymer, namely polyparaphenylene, was used as plastic material and the proportions of TiC particles were varied. 5.5% by weight, 11% by weight and 22% by weight were used for the rings according to the invention.

In this case, a drastic effect in the reduction of the abrasion is already displayed with 5.5% by weight of TiC particles. In the case of higher amounts, the abrasion increases first of all (11% by weight) whereas when the TiC amounts are increased further (22% by weight) the abrasion is reduced again. This peculiarity is observed in the case of self-reinforcing polymers. Similar ratios will presumably be observed in the case of fiber-reinforced plastics which do not, however, suggest themselves for the production of retaining rings for semiconductor wafers.

### Example 4

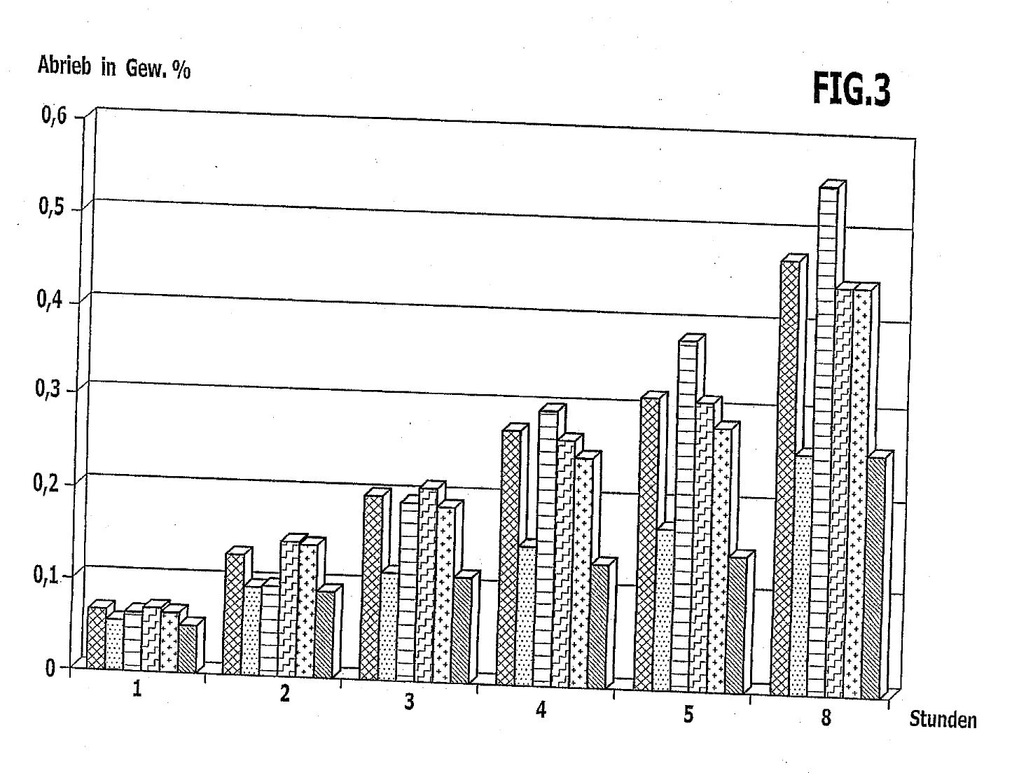

In this example, the abrasion values of different high performance plastic materials are contrasted with one another for the purpose of comparison. The abrasion data are summarized in FIG. 3, wherein the columns showing the abrasion represent the following plastic materials starting from left to right:

Standard PPS

PET

PEEK

PEEK with 10% by weight of PTFE

PEKK

Polyparaphenylene.

Comparatively good values, which can be improved further with the use of the filler TiC in accordance with the invention, already result for the plastic material PET from the diagram of FIG. 3.

PET is suitable as a matrix material for the retaining rings but only for simple semiconductor structures, such as, e.g., in the case of memory chips, whereas the high performance plastic materials PPS, PEEK and polyparaphenylene are preferred for complex semiconductor structures, such as, e.g., in the case of processor chips.

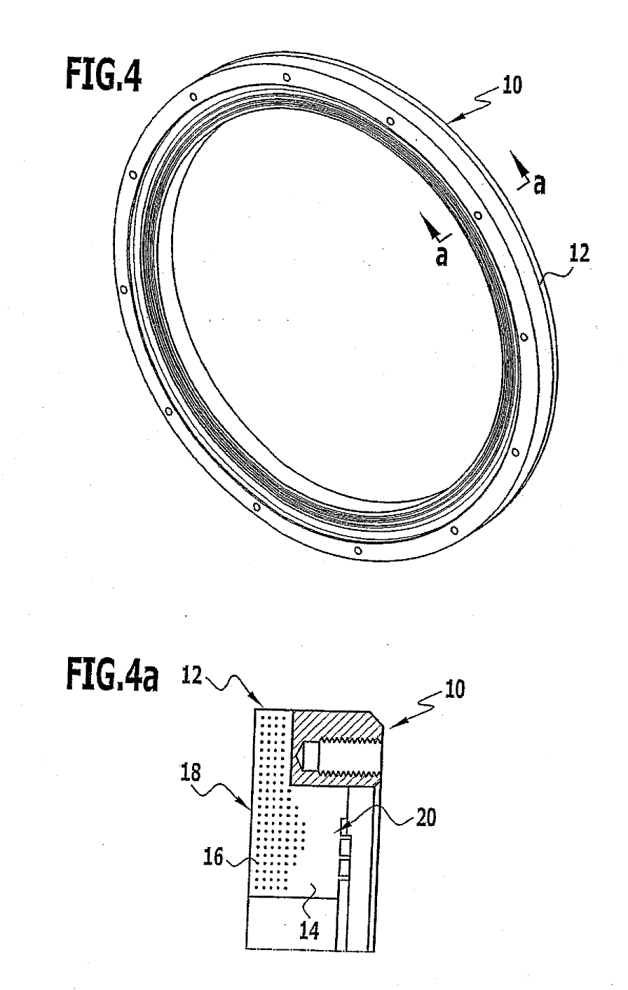

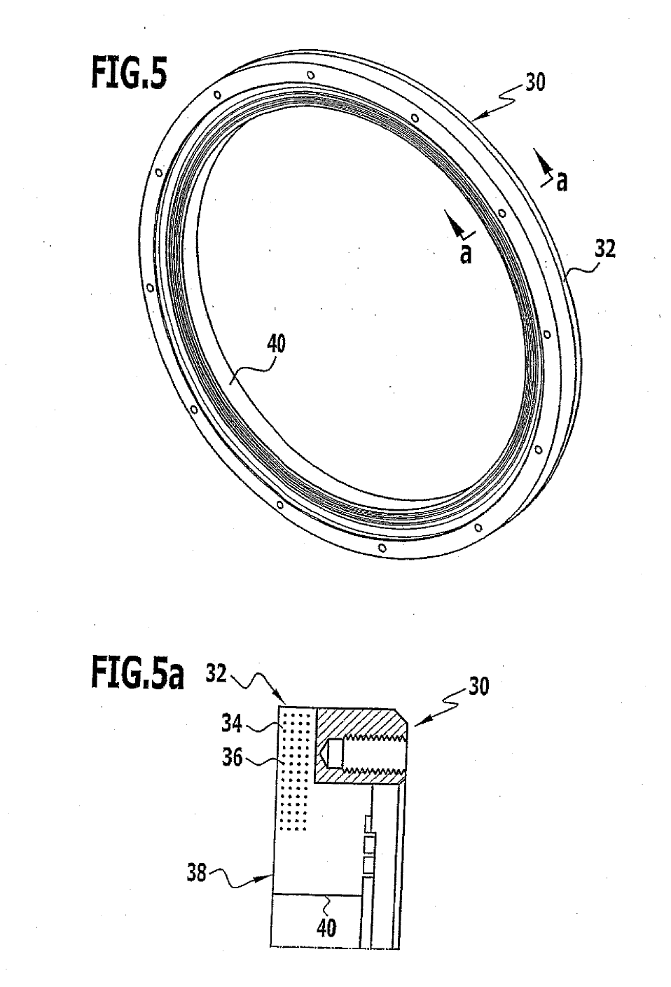

Finally, FIGS. 4 and 5 show schematically retaining rings 10 and 30, respectively, according to the invention, which have a wear and tear layer 12 and 32, respectively, with a plastic matrix 14 and 34, respectively, into which TiC particles 16 and 36, respectively, are integrated.

The retaining ring 10 shown in FIG. 4 (with an enlarged sectional illustration in FIG. 4a) has in the wear and tear layer an amount of TiC particles which is greater adjacent to the abrasively stressed surface 18 than in areas 20 which are not subject to any abrasion.

In the case of plastic materials which are cheaper with respect to the price of raw materials than the TiC material, this particle distribution is recommended. If the price for the material of the high performance plastic material which forms the matrix is higher than the price for the TiC material, a uniform amount of TiC particles can, of course, be used in the entire cross section of the wear and tear layer with a view to minimizing costs without any disadvantage.

FIG. 5 (with an enlarged sectional illustration in FIG. 5a) shows the retaining ring 30 with a TiC particle distribution which is further modified, wherein the TiC particles are omitted in areas 38 adjacent to the inner surface 40 of the retaining ring 30 in order to increase the certainty that the wafers arranged within the retaining ring do not come into contact with the TiC particles contained in the abrasion.

FIGS. 4 and 5 show respective one-part retaining rings in accordance with US patent application US 2004-0065412 A. It goes without saying that the plastic materials according to the invention may also be used just as well and with the same result with respect to the improvement of the abrasion and wear characteristics in the case of one-part retaining rings in accordance with US patent application 2004-0067723 A.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A plastic material for the production of tribologically stressed components, wherein the plastic material comprises a plastic matrix and particulate TiC embedded therein.

2. The plastic material as defined in claim 1, wherein the plastic material is selected from polyether ether ketone, polyphenylene sulfide, polyparaphenylene, PTFE-modified polyether ether ketone, PFA-modified PTFE, polyether ketone ketone, polyalkylene terephthalate, polyimide, polyamide imide and polysulfone.

3. The plastic material as defined in claim 1, having an amount of particulate TiC in the plastic material of up to 30% by weight.

4. The plastic material as defined in claim 3, wherein the amount of particulate TiC in the plastic material is up to 25% by weight.

5. The plastic material as defined in claim 4, wherein the amount of particulate TiC in the plastic material is 20 to 25% by weight.

6. The plastic material as defined in claim 1, wherein the particulate TiC has an average particle size of 1 to 2 μm.

7. The plastic material as defined in claim 1, wherein the particulate TiC has a layer of adhesion agent on the surface of the particles.

8. The plastic material as defined in claim 7, wherein the layer of adhesion agent contains an organic polymer.

9. The plastic material as defined in claim 1, wherein the TiC particles are partially fluorinated.

10. The plastic material as defined in claim 1, wherein the particulate TiC is granular.

11. The plastic material as defined in claim 1, wherein the TiC particles have a smooth surface.

12. The plastic material as defined in claim 1, wherein a self-reinforcing plastic, is selected as plastic material for the matrix and having an amount of particulate TiC of 3 to 8% by weight.

13. A tribologically stressed component comprising the plastic material in accordance with claim 1, wherein the component has a wear and tear layer.

14. The component as defined in claim 13, having abrasively stressed surface areas and areas subjected to no abrasive stressing, wherein the amount of particulate TiC adjacent to abrasively stressed surface areas of the component is greater than in areas subjected to no abrasive stressing.

15. The component as defined in claim 13, wherein the component is a retaining ring for semiconductor wafers.

16. The component as defined in claim 15, wherein the wear and tear layer is essentially free from TiC particles adjacent to the surface of the retaining ring located radially inwards.

17. A process for the production of a component in accordance with claim 13, comprising:
a) Compounding the plastic material selected for the matrix with the particulate TiC;
b) preparing the compounded plastic material to form a sinterable granulate;
c) sintering the granulate obtained in b) at a predetermined sintering temperature to form a wear and tear layer;
d) controlled cooling of the sintered material from the sintering temperature to achieve a predetermined degree of crystallization and to reduce tensions in the wear and tear layer.

18. A process for the production of a component in accordance with claim 13, comprising:
a) Compounding the plastic material selected for the matrix with the particulate TiC;
b) extruding the compounded material to form a wear and tear layer;
c) tempering the extruded wear and tear layer to achieve a predetermined degree of crystallization and to reduce tensions in the wear and tear layer.

19. The plastic material according to claim 1, wherein the plastic material is selected from polyphenylene sulfone and polyether sulfone.

20. The plastic material according to claim 6, wherein the particulate TiC has an average particle size of 1.2 to 1.4 μm.

21. The plastic material according to claim 8, wherein the organic polymer contains fluorine.

22. The plastic material according to claim 10, wherein the particulate TiC is spherical.

23. The plastic material according to claim 12, wherein the self-reinforcing plastic is polyparaphenylene.
